(19) United States
(12) Patent Application Publication
(10) Pub. No.: US 2025/0299367 A1
(43) Pub. Date: Sep. 25, 2025

(54) ONLINE CALIBRATION WITH CONVOLUTIONAL NEURAL NETWORK OR OTHER MACHINE LEARNING MODEL FOR VIDEO SEE-THROUGH EXTENDED REALITY

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 18/938,028

(22) Filed: Nov. 5, 2024

Related U.S. Application Data
(60) Provisional application No. 63/567,370, filed on Mar. 19, 2024.

(51) Int. Cl. G06T 7/80; G06F 3/01; G06T 5/60; G06T 5/80; G06T 19/00

(52) U.S. Cl. CPC G06T 7/80; G06T 5/60; G06T 5/80; G06T 19/006; G06F 3/012; G06T 2207/10016; G06T 2207/10024; G06T 2207/20081; G06T 2207/20084

(57) ABSTRACT

A method includes obtaining an image frame using at least one see-through camera of a VST XR device. The method also includes applying a first correction to the image frame based on one or more intrinsic parameters of the at least one see-through camera. The method further includes applying a second correction to the image frame based on one or more intrinsic parameters of at least one display lens of the VST XR device. In addition, the method includes, after applying the first correction and the second correction, displaying the image frame on at least one display visible through the at least one display lens. The one or more intrinsic parameters of the at least one see-through camera are determined using a first machine learning model, and the one or more intrinsic parameters of the at least one display lens are determined by a second machine learning model.

### CROSS-REFERENCE TO RELATED APPLICATION AND PRIORITY CLAIM

This application claims priority under 35 U.S.C. § 119 (e) to U.S. Provisional Patent Application No. 63/567,370 filed on Mar. 19, 2024, which is hereby incorporated by reference in its entirety.

### TECHNICAL FIELD

This disclosure relates generally to extended reality (XR) systems and processes. More specifically, this disclosure relates to online calibration with a convolutional neural network or other machine learning model for video see-through (VST) XR.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes. Often times, images can be projected via a small screen and be magnified and focused onto a plane of the user's eyes via one or more display lenses.

### SUMMARY

This disclosure relates to online calibration with a convolutional neural network or other machine learning model for video see-through (VST) extended reality (XR).

In a first embodiment, a method includes obtaining an image frame using at least one see-through camera of a VST XR device. The method also includes applying a first correction to the image frame based on one or more intrinsic parameters of the at least one see-through camera. The method further includes applying a second correction to the image frame based on one or more intrinsic parameters of at least one display lens of the VST XR device. In addition, the method includes, after applying the first correction and the second correction, displaying the image frame on at least one display visible through the at least one display lens. The one or more intrinsic parameters of the at least one see-through camera are determined using a first machine learning model, and the one or more intrinsic parameters of the at least one display lens are determined by a second machine learning model.

In a second embodiment, a VST XR device includes at least one see-through camera. The VST XR device also includes at least one display lens and at least one display, where the at least one display is configured to be viewed through the at least one display lens. The VST XR device further includes at least one processing device configured to obtain an image frame using the at least one see-through camera, apply a first correction to the image frame based on one or more intrinsic parameters of the at least one see-through camera, and apply a second correction to the image frame based on one or more intrinsic parameters of the at least one display lens. The at least one processing device is also configured, after applying the first correction and the second correction, to initiate display of the image frame on the at least one display. The one or more intrinsic parameters of the at least one see-through camera are determined using a first machine learning model, and the one or more intrinsic parameters of the at least one display lens are determined by a second machine learning model.

In a third embodiment, a non-transitory machine-readable medium contains instructions that when executed cause at least one processor to obtain an image frame using at least one see-through camera of a VST XR device. The non-transitory machine-readable medium also contains instructions that when executed cause the at least one processor to apply a first correction to the image frame based on one or more intrinsic parameters of the at least one see-through camera. The non-transitory machine-readable medium further contains instructions that when executed cause the at least one processor to apply a second correction to the image frame based on one or more intrinsic parameters of at least one display lens of the VST XR device. In addition, the non-transitory machine-readable medium contains instructions that when executed cause the at least one processor, after applying the first correction and the second correction, to initiate display of the image frame on at least one display visible through the at least one display lens. The one or more intrinsic parameters of the at least one see-through camera are determined using a first machine learning model, and the one or more intrinsic parameters of the at least one display lens are determined by a second machine learning model.

Any one or any combination of the following features may be used with the first, second, or third embodiment. The first correction and the second correction may be applied in conjunction with passing the image frame through a processing pipeline for generating an XR display based on the image frame. The first and second corrections may be applied prior to or simultaneously with performing a correction for a predicted head pose of a user of the VST XR device. The image frame may include image data in each of a plurality of color channels, and the second correction may be applied separately for each of the color channels. A determination may be made whether to calibrate the VST XR device for distortion in the at least one see-through camera and/or distortion from the at least one display lens. Responsive to determining to calibrate the VST XR device, the image frame may be provided to one or more of the first and second machine learning models, and one or more updated intrinsic parameters of the one or more see-through cameras and/or one or more updated intrinsic parameters of the at least one display lens may be received from one or more of the first and second machine learning models. At least one of the first and second machine learning models may be remote from the VST XR device. The one or more intrinsic parameters of the at least one display lens may include barrel distortion and/or chromatic aberration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example of providing a video see-through (VST) extended reality (XR) display in accordance with this disclosure;

FIG. 3 illustrates an example system including an online calibration pipeline and a VST XR pipeline in accordance with this disclosure;

FIG. 4 illustrates an example calibration pipeline for online calibration in accordance with this disclosure;

FIG. 5 illustrates aspects of an example display lens distortion model for online calibration of a VST XR device in accordance with this disclosure;

FIG. 6 illustrates an example training process to train a machine learning model to predict distortion coefficients for a display lens of a VST XR device in accordance with this disclosure;

FIG. 7 illustrates an example distortion model for a see-through camera in accordance with this disclosure;

FIG. 8 illustrates an example training process to train a machine learning model to generate distortion coefficients describing distortions to image data caused by a lens of a see-through camera in accordance with this disclosure; and

FIG. 9 illustrates an example method for online calibration of a VST XR device in accordance with this disclosure.

### DETAILED DESCRIPTION

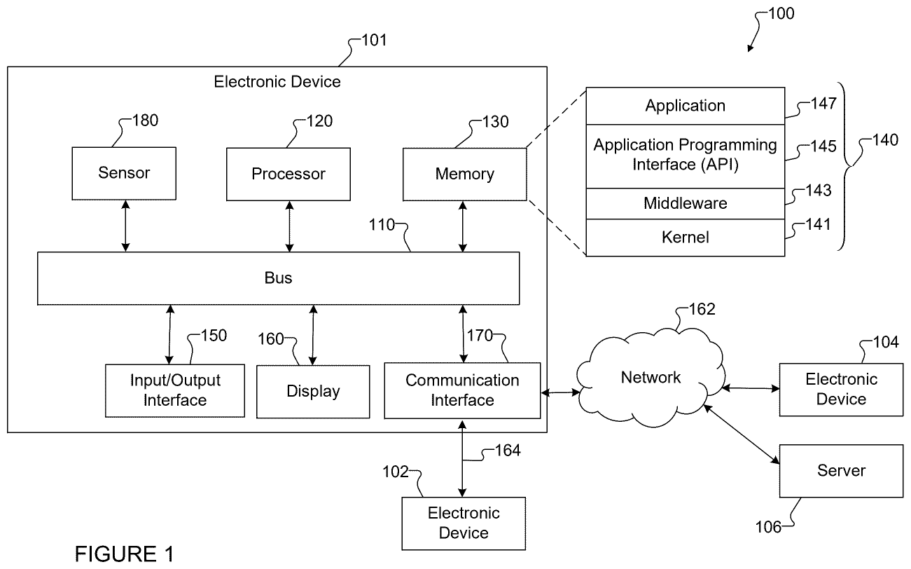

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes. Often times, images can be projected via a small screen and be magnified and focused onto a plane of the user's eyes via one or more display lenses.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

VST XR devices typically use see-through cameras to capture image frames of their surrounding environments. Image frames captured using the see-through camera(s) of a VST XR device can be processed and presented (possibly along with various modifications as needed or desired) to a user of the VST XR device on one or more displays. However, given the typically-small sizes of the displays used in VST XR devices and the positioning of the displays relative to the users' eyes, a user typically views one or more display screens through one or more display lenses.

Generating and presenting a view of an operating environment at a VST XR device while providing a workable facsimile of a user's natural view of the operating environment presents many challenges, including minimizing latencies, matching a view presented at the VST XR device with the user's native understanding of his or her head pose, and tuning image frame data of the operating environment to match optical properties of the user's own eyes. To match the view presented at a VST XR device with a user's head pose at the instant an XR display is shown to the user and to add items of virtual content to the view, XR systems often implement one or more XR pipelines. These XR pipelines may implement a number of functions, such as pose prediction and simultaneous location and mapping (“SLAM”) adjustments.

Tuning image frame data that is obtained by see-through cameras, projected by displays, and viewed via display lenses typically involves performing various corrections to account for different distortions or other issues. While distortions and other deviations can be corrected by testing and calibrating a VST XR device during manufacturing, such factory calibration only provides a partial solution to offsetting the effects of see-through cameras and display lenses. For example, during use, a VST XR device may require re-calibration, such as due to damage, wear and tear, or other factors affecting the optical properties of the display lenses or see-through cameras. As a particular example, the locations of the display lenses may shift slightly in response to accidental dropping of the VST XR device. Additionally, reliance on factory calibration to correct for the effects of the intrinsic properties of the see-through cameras and display lenses can preclude post-manufacture calibration or refinement of calibration parameters.

This disclosure provides various techniques for online calibration with a convolutional neural network or other machine learning model for VST XR devices. As described in more detail below, various embodiments of this disclosure provide mechanisms for post-factory calibration of VST XR devices to compensate for lens distortions or other perceptible discrepancies between a VST XR view of an operating environment and a natural view of the operating environment. Among other things, correction values normally obtained at factory calibration may be obtained using one or more convolutional neural networks (CNNs) or other machine learning models. Accordingly, embodiments of this disclosure provide various advantages or benefits, such as on-demand post-factory calibration and re-calibration of VST XR devices and mechanisms for further refinement of correction values.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to online calibration with a convolutional neural network or other machine learning model for VST XR.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform online calibration with a convolutional neural network or other machine learning model for VST XR. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user. In some embodiments, display 160 can be a miniaturized display of a head mounted display (HMD) positioned in front of one or both of a user's eyeballs and configured to be viewed by a user through one or more display lenses.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. In certain embodiments, second electronic device 101 can perform one or more operations (such as training or providing inputs to a first or second machine learning model) of embodiments as described herein, and provide outputs, via communication interface 170 to electronic device 101. The communication interface 170 can be a wired or wireless transceiver or any other component for transmitting and receiving signals.

The wireless communication is able to use at least one of, for example, Wi-Fi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 include cameras or other imaging sensors, which may be used to capture image frames scenes. For example, sensor(s) 180 can include one or more see-through cameras for capturing image frames of an operating environment of electronic device to support a VST XR display provided through display 160. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the second electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to online calibration with a convolutional neural network or other machine learning model for VST XR.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

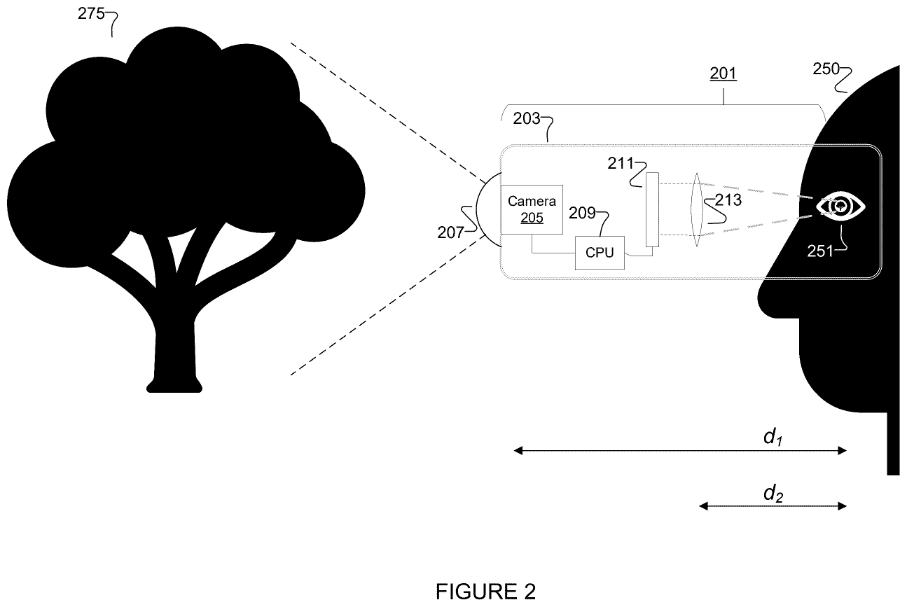

FIG. 2 illustrates an example of providing a VST XR display in accordance with this disclosure. As shown in FIG. 2, a VST XR device 201 for providing an XR display is shown. In this example, the VST XR device 201 can be worn on the head of a user 250 and includes an external housing 203 that blocks out the user's native view of his or her operating environment. In this particular example, the operating environment includes a tree 275, although this is merely for illustration only. The VST XR device 201 also includes at least one see-through camera 205, each of which may include a camera lens 207. Here, the see-through camera 205 is disposed at a first distance d₁ from an eye 251 of the user 250. The see-through camera 205 is connected to at least one processor 209, which may represent the processor 120 in FIG. 1. The processor 209 is connected to and controls at least one display 211, which may represent the display 160 in FIG. 1. Here, the display 211 is disposed at a second distance d₂ relative to the eye 251 of the user 250. In this example, light emitted from the display 211 passes through a display lens 213, which has a focal length and shape designed to magnify and focus the light from the display 211 upon the eye 251.

In an XR display provided by the VST XR device 201, image frames of the user's operating environment captured by the see-through camera 205 are processed by the processor 209 and presented via the display 211. The XR display obtained from the image frames and presented to the user appears as a serviceable replacement for the view of the operating environment the user would see natively through his or her eye 251. As shown in FIG. 2, to make the generated view of the operating environment appear to the user 250 as a serviceable facsimile (such as close enough to the user's native view so as to not cause motion sickness or to achieve a desired level of quality), the view displayed at the display 211 may be corrected for one or more of the following:
pincushion, barrel, or other distortions due to the shape of the lens 207;
differences in depth projection due to differences in effective focal lengths of the lens 207 and the eye 251 (such as when a wide-angle lens makes background objects appear further away than the “normal” length lens of the human eye);
the distance d₁ between the viewpoint of the see-through camera 205 and the eye 251;
pincushion, barrel, or other distortions due to the shape of the display lens 213;
chromatic aberrations due to the shape and refractive index of the display lens 213; and/or
changes in a head pose of the user 250 during a time interval between capture of an image frame at the see-through camera, processing, correction, and presentation of an XR display based on the image frame at the display 211.

In some embodiments, the processor 209 can implement a VST XR pipeline to compensate for changes in head pose during the processing interval between image frame capture and presentation at the display 211 and to perform other functions. In binocular VST XR devices having right and left see-through cameras, the VST XR pipeline can perform depth adjustments of image frames to provide separate displays at left and right displays, which convey a realistic sense of depth. For example, U.S. Patent Publication No. 2014/0223742 A1 (which is hereby incorporated by reference in its entirety) describes various embodiments of VST rendering pipelines suitable for use with embodiments of this disclosure.

As noted earlier, parameters for correcting distortions, chromatic aberrations, and other unwanted optical effects due to the shape and intrinsic properties of the lenses 207 and 213 can be determined during factory calibration and loaded into a memory of the VST XR device 201 for application by the VST XR pipeline or other process implemented by the processor 209. While factory calibration can be effective, opportunities for improvement and performing post-factory re-calibration remain. Embodiments of this disclosure utilize one or more CNNs or other machine learning models to obtain correction parameters for post-factory re-calibration involving intrinsic optical properties of one or both of the see-through camera 205 and the display lens 213.

Although FIG. 2 illustrates one example of providing a VST XR display, various changes may be made to FIG. 2. For example, the processor 209 could be provided on a separate device communicatively connected to the device 201. Also, the VST XR device 201 may include any number of each component in any suitable arrangement. In addition, while FIG. 2 illustrates one example operational environment in which various features disclosed in this patent document can be used, these features could be used in any other suitable system.

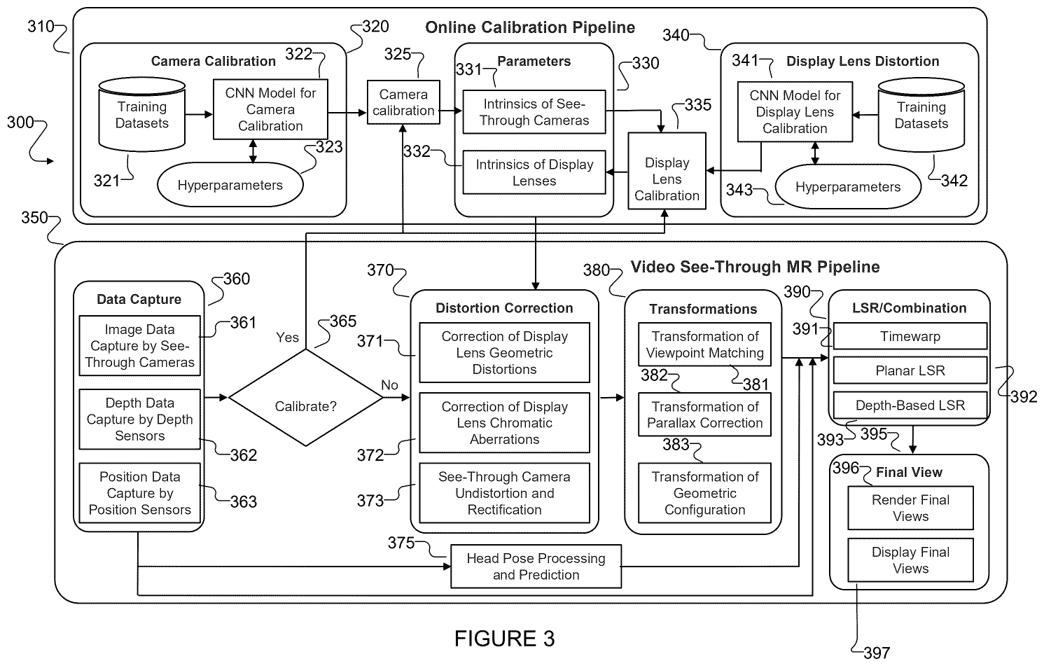

FIG. 3 illustrates an example system 300 including an online calibration pipeline 310 and a VST XR pipeline 350 in accordance with this disclosure. The example system 300 can be implemented according to a variety of hardware architectures, including on a single processing platform (such as the VST XR device 201 in FIG. 2) or across multiple devices (such as the electronic devices 101, 102, 104 and/or server 106 in FIG. 1). Depending on the design objectives (such as minimizing weight and heat build-up at a VST XR device), multi-device architectures might be desired to avoid performing all of the processing at a device worn on a user's head.

As shown in FIG. 3, in some embodiments, two separate pipelines for correcting image frame data from a see-through camera for presentation at a display may be implemented, namely the online calibration pipeline 310 and the video see-through XR pipeline 350. The online calibration pipeline 310 can include a camera calibration operation 320, a parameter identification operation 330, and a display lens distortion operation 340. The camera calibration operation 320 can include a first CNN model 322 for camera calibration, as well as one or more training datasets 321 that are stored in memory or otherwise accessible to the camera calibration operation 320. The CNN model 322 can be trained using the training dataset(s) 321 to recognize features in image frames obtained from at least one see-through camera of the VST XR device. The identified features in the image frames can be associated with distortions and artifacts in image frame data captured by the see-through camera(s) that are intrinsic to the see-through camera(s). Examples of such intrinsic distortions and artifacts may include pincushion or barrel distortions and chromatic aberrations. By training on the training dataset(s) 321, the CNN model 322 can learn relationships between distorted images and distortion coefficients of the see-through camera(s) and save the relationship(s) as weights or hyperparameters 323.

In some embodiments, the CNN model 322 can be initially pre-trained at the factory or with an initial firmware installation based on an initial instance of the training dataset 321. Post-factory training and refinement of the CNN model 322 is also possible by augmenting the data in the training dataset 321. For example, the training dataset 321 can be augmented based on additional training data obtained during operation of the VST XR device implementing the online calibration pipeline 310. For example, instances in which a user indicates that the VST XR device needs further calibration could trigger reweighting of features in the CNN model 322 or replacement of data in the training dataset 321. Additionally, the training dataset 321 could be augmented or refined based on additional information, such as depth data (like depth map data obtained using a LIDAR sensor or stereo camera pair) associated with image frames of an operating environment.

The display lens correction operation 340 can include a second CNN model 341 for display lens calibration. The CNN model 341 can be trained and re-trained to generate correction values for offsetting distortions and visible artifacts due to one or more display lenses (such as display lens 213 in FIG. 2). The CNN model 341 can be trained at least in part with one or more training datasets 342. The CNN model 341 can learn, such as through supervised or unsupervised learning, the relationships between distortions in image frames and coefficients of the display lens(es) and save the relationship(s) as weights or hyperparameters 343. In some cases, the CNN model 341 can be pre-trained on an initial version of the training dataset 342 for initial use in the display lens distortion operation 340. As with the training dataset 321, the training dataset 342 can be augmented and refined with additional or different data. For example, the training dataset 342 can be augmented based on additional training data obtained during operation of the VST XR device implementing online calibration pipeline 310. For example, instances in which a user indicates that the VST XR device needs further calibration could trigger reweighting of features in the CNN model 341 or replacement of data in the training dataset 342. Additionally, the training dataset 342 can be augmented or refined based on additional information, such as eyeball tracking data indicating squinting, blinking, or unexpected eye movements due to less-than-optimal correction for display lens distortion.

The VST XR pipeline 350 handles ingestion of frames of image data from one or more see-through cameras and processing and correcting views of an operating environment as captured in the frames of image data to provide a workable facsimile for the view a user would obtain through his or her eyes. The VST XR pipeline 350 can also render image frames that include items of virtual content such that the user views a “mixed reality” display that mixes views of the real-world operating environment outside of the VST XR device with one or more virtual elements. In some embodiments, the VST XR pipeline 350 includes a data capture operation 360, distortion correction operation 370, transformation operation 380, late stage reprojection (LSR) combination operation 390, and final view operation 395.

In some embodiments, the data capture operation 360 ingests raw or partially-processed data used for generating an XR frame to be presented to the user through one or more displays (such as the display 211 in FIG. 2). Also, in some embodiments, depth data and motion sensor data for performing depth correction and for predicting a user's head pose at the time of presentation can be obtained. Depth correction may be performed to ensure that the perceived distance between objects in an XR presentation generally conforms to the distance perception provided by the “normal” lenses of a user's eyes. Examples of data captured by the data capture operation 360 could include image frames 361 obtained by one or more see-through cameras of a VST XR device, depth data 362 obtained from one or more depth sensors (such as a LIDAR sensor or determined from a stereoscopic camera pair), and position data 363 determined from one or more position sensors (such as six degree-of-freedom accelerometers).

A calibration determination operation 365 performs a determination whether calibration or re-calibration of the system is to be performed, such as to account for distortions or optical effects introduced by one or both of the see-through camera(s) or the display lens(es). The determination performed by the calibration determination operation 365 can be performed based on one or more factors, such as user input requesting calibration/recalibration of the system, a predetermined schedule for calibration/recalibration (like recalibrating at startup and/or specified operating intervals), or in response to detected anomalies in the image frames.

Responsive to determining that calibration/recalibration is indicated, a camera calibration operation 325 of the online calibration pipeline 310 is triggered. The camera calibration operation 325 computes see-through camera lens distortion coefficients 331 based on the hyperparameters 323 determined by the CNN model 322. In some embodiments, obtaining the see-through camera lens distortion coefficients may include providing one or more image frames 361 to the CNN model 322 for analysis of the image frames for features associated with specific distortions and the CNN model 322 outputting distortion parameters for a corrective warp of the image frame(s).

Similarly, responsive to determining that calibration/recalibration is indicated, a lens display calibration operation 335 of the online calibration pipeline 310 is triggered. The lens display calibration operation 335 computes display lens distortion coefficients 332 based on the hyperparameters 343 determined by the CNN model 341. In some embodiments, obtaining the display lens distortion coefficients 332 may include providing one or more image frames 361 to the CNN model 341 for analysis of features associated with specific distortions or display lens-induced artifacts and the CNN model 341 outputting distortion coefficients for a corrective warp of the image frame(s).

At a high level, calibrating for camera effects and display lens effects is a two-step process, including “undistorting” captured image frames 361 at the camera calibration operation 320 to correct for distortions from a natural (such as human eye) view introduced by the see-through camera(s) and slightly “redistorting” the corrected see-through camera image frames at the display lens distortion operation 240 to offset distortions and other effects introduced by projecting images through the display lens(es). Put differently, the camera calibration operation 325 can determine camera lens distortion coefficients 331 by providing one or more image frames 361 to the CNN model 322, and the computed camera lens distortion coefficients 331 can be saved to the parameter identification operation 330. Similarly, the display lens distortion operation 340 can undistort the image frames 361 with the computed camera lens distortion coefficients 331, and the lens display calibration operation 335 can compute the display lens distortion coefficients 332 with the CNN model 341. The computed display lens distortion coefficients 332 can be stored in the parameter identification operation 330. The parameters computed by the online calibration pipeline can be used by the VST XR pipeline 350.

In some embodiments, the distortion correction operation 370 applies the display lens distortion coefficients 332 and see-through camera lens distortion coefficients 331 to “undistort” image frames obtained from the one or more see-through cameras to a “normal” view of an operating environment that provides a serviceable replacement for a user's native view of the operating environment. The distortion correction operation 370 also slightly “redistorts” the undistorted image frame to offset the distortions introduced by the one or more display lenses, as well as to further correct for chromatic aberrations introduced by the one or more display lenses.

As shown in FIG. 3, the distortion correction operation 370 includes a processing pipeline that includes a first correction operation 371 (using the display lens coefficients 332) for display lens geometric distortions, a second correction operation 372 for display lens chromatic aberrations, and a third correction operation 373 based on the display lens coefficients 332 obtained from the online calibration pipeline 310. The distortion correction operation 370 performs the third correction 373 to correct for see-through camera distortions and rectify image frame data based on the camera lens distortion coefficients 331 from the online calibration pipeline 310. In some embodiments, each image frame 361 is split into data in constituent channels of a color space of the see-through camera (such as a CMYK or RGB color space), and the second correction 372 is performed separately for each color channel.

Once corrected for capture and projection distortions and visual artifacts by the distortion correction operation 370, the image frame(s) 361 can be passed to the transformation operation 380. In some embodiments, the transformation operation 380 performs a first correction operation 381 for viewpoint matching, a second correction operation 382 to correct for parallax effects, and a third correction operation 383 including a geometric transformation based on the first and second corrections 381 and 382. The third correction operation 383 can transform the see-through frames from see-through camera viewpoint(s) to the viewpoint(s) of the user's eye(s). Collectively, the first, second and third transformation operations 381-383 perform reprojections to make image frames provided by the VST XR device appear as if they were obtained from the viewpoint(s) of the viewer's own eye(s). For example, the first correction operation 381 may determine the distance or spatial difference between the see-through camera(s) and the user's eye(s). The second correction operation 382 may determine the projection effects associated with the differences in parallax between a stereoscopic pair of see-through cameras of the VST XT device and the parallax distance between the user's eyes. The third correction operation 383 “puts together” the first and second corrections 381 and 382 as a geometric transformation to be applied to the image frame(s) 361.

The VST XR pipeline 350 may further include a head pose processing and prediction operation 375, which takes at least some of the data captured by the data capture operation 360 to predict and estimate a change in the user's head pose (such as the change in viewing location and viewing angle) during the brief latency period between capture of an image frame 361 and display of a final view based on that image frame 361. In this way, VST see-through images presented to the user are images whose viewpoint substantially corresponds to the user's native understanding of his or her viewpoint (based on his or her inner ear and other sources of bodily proprioception). Among other things, motion sickness and other unwanted byproducts of mismatches between the user's actual head pose and the pose of the VST XR displays based on captured image frames can be reduced or avoided. In this example, the head pose processing and prediction operation 375 operates in parallel with the distortion correction operation 370 and the transformation operation 380.

As shown in FIG. 3, frames of image data can be passed from the transformation operation 380 to the LSR and combination operation 390, which “updates” the image frame data according to the user's predicted head pose at the time of display as determined by the head pose processing and prediction operation 375. For example, the LSR and combination operation 390 can correct for the change in head pose during the time interval between the capture of an image frame 361 and the display of the associated final VST view. This may be accomplished in any suitable manner, such as by using one or more reprojection techniques like time warp reprojection 391, planar late stage reprojection 392, or depth-based LSR 393.

Following late-stage reprojection to synchronize the head pose of each image frame 361 with the user's predicted head pose, the image frame 361 passes to the final view operation 395, which includes a render view rendering operation 396 that renders a final view frame. The rendering may include adding visual effects (such as recoloring) and insertion of items of virtual content (such as objects that appear to float or be positioned on real-world objects appearing in the image data of the operating environment). The rendered image frames are provided to a final view display operation 397, which presents the rendered image frames on at least one display (such as the display 211 in FIG. 2) for viewing through the display lens(es).

Although FIG. 3 illustrates one example of a system 300 including an online calibration pipeline 310 and a VST XR pipeline 350, various changes may be made to FIG. 3. For example, various components or functions in FIG. 3 may be combined, further subdivided, replicated, omitted, or rearranged and additional components or functions may be added according to particular needs. In some cases, for instance, one or more processors implementing the pipelines 310 and 350 may be capable of multithreading, and FIG. 3 does not limit the scope of this disclosure to any single sequence of operations. Moreover, while FIG. 3 presents an example of a system utilizing convolutional neural networks as models, the present disclosure is not so limited, and other types of trainable machine learning models are possible and within the contemplated scope of this disclosure.

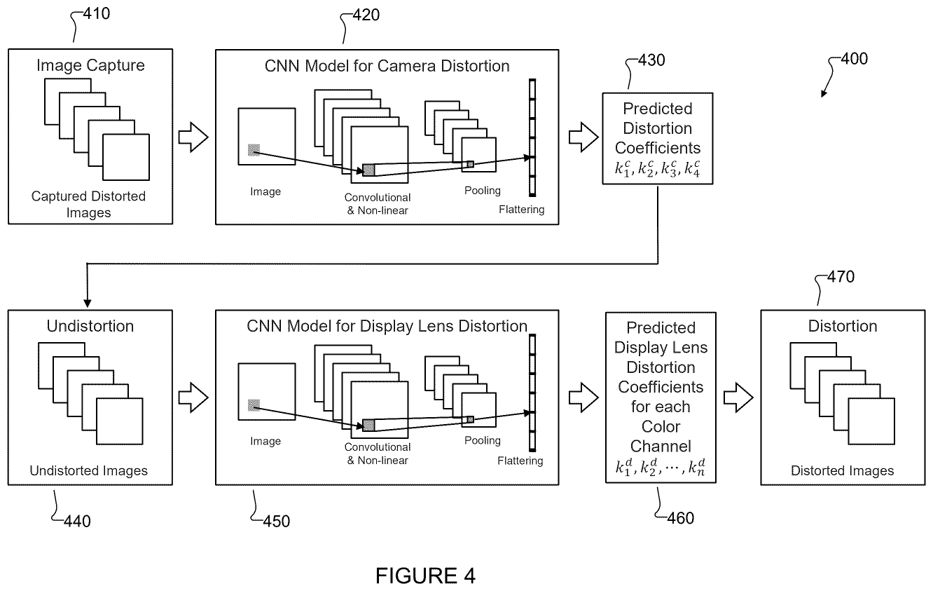

FIG. 4 illustrates an example calibration pipeline 400 for online calibration in accordance with this disclosure. The calibration pipeline 400 here can be used to perform a sequence of “undistortion” and “redistortion” operations for initially correcting for the distortions of the see-through camera(s) and mildly “redistorting” image frames to offset the distortions and chromatic effects introduced by the display lens(es) and to describe the role of distortion coefficients in some embodiments. In some cases, for example, the calibration pipeline 400 may represent the calibration pipeline 310 of FIG. 3.

During an image capture operation 410 of the calibration pipeline 400, frames of image data are captured by one or more see-through cameras of a VST XR device and ingested by the calibration pipeline 400. Apart from being processed to conform to a specified data format (such as RAW or JPEG format), the frames of image data received at the image capture operation 410 can otherwise be straight-out-of-camera (“SOOC”) and contain distortions imparted by the see-through camera lens(es). A CNN model 420 (which could represent the CNN model 322 in FIG. 3) processes the distorted images obtained by the image capture operation 410 by passing the image frames through a pre-trained CNN model, which predicts distortion coefficients describing the distortions from a normal length lens view. The CNN model 420 outputs a first set of predicted distortion coefficients 430. As described elsewhere, the distortion coefficients 430 reflect shifts in a coordinate system describing a desired view of a scene (such as a view of a scene through a lens having equivalent focal properties to a human eye) and the view of the scene in the captured image frames.

An undistortion operation 440 applies the distortion coefficients k₁^{c}, k₂^{c}, k₃^{c}, k₄^{c} to one or more frames of image data to reproject the image frame(s) from the coordinate system associated with the see-through camera(s) to a coordinate system associated with one or more normal lens views, thereby producing undistorted image frames. Following undistortion of the image frames, the undistorted image frames are provided to a second CNN model 450 (which could represent the CNN model 341 in FIG. 3), which predicts distortion coefficients k₁^{d}, k₂^{d}, . . . , kₙ^{d} describing distortions from the display lens(es). In some embodiments, the image frame data may be separated into multiple channels corresponding to the constituent channels of the color space used by the see-through camera(s), and each channel may be passed through the CNN model 450 separately. The CNN model 450 outputs a second set of predicted distortion coefficients 460. Using the predicted distortion coefficients for the display lens(es), the image frames can be slightly “redistorted” by performing a warp based on the predicted distortion coefficients k₁^{d}, k₂^{d}, . . . , kₙ^{d} to compensate for distortions and chromatic aberration caused by the display lens(es). The “redistorted” image frames 470 can be presented via at least one display that is configured to be viewed through the display lens(es).

Although FIG. 4 illustrates one example of a calibration pipeline 400 for online calibration, various changes may be made to FIG. 4. For example, various components or functions in FIG. 4 may be combined, further subdivided, replicated, omitted, or rearranged and additional components or functions may be added according to particular needs. Moreover, while FIG. 4 presents an example of a pipeline utilizing convolutional neural networks as models, the present disclosure is not so limited, and other types of trainable machine learning models are possible and within the contemplated scope of this disclosure.

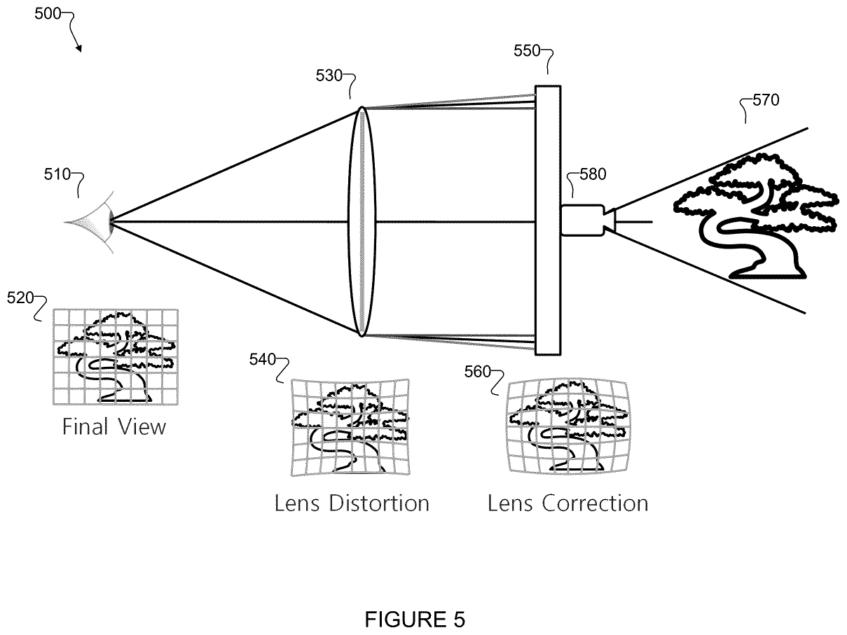

FIG. 5 illustrates aspects of an example display lens distortion model 500 for online calibration of a VST XR device in accordance with this disclosure. For example, the display lens distortion model 500 may be used to model the behavior of the display lens 213 in FIG. 2. Also, in some cases, the display lens distortion model 500 may have parameters that a CNN model (such as the CNN model 341 in FIG. 3 or the CNN model 450 in FIG. 4) can be trained to learn.

As shown in FIG. 5, a three-dimensional scene 570 of an operating environment of a VST XR device with a see-through camera 580 is captured by the see-through camera 580. First corrections 560 (such as the corrections applied by the undistortion operation 440 of FIG. 4) are applied to remove distortions (such as pincushion distortion from a wide-angle or fisheye lens of the see-through camera 580). An image of the scene 570 based on the processed image frame(s) of the scene can be rendered on a display 550 after passthrough transformations, and a user's eye 510 can view the image on the display 550 through a display lens 530.

As noted elsewhere in this disclosure, the display lens 530 can create distortion 540 (such as pincushion distortion), which can be offset by applying a first correction 560 that “redistorts” a previously corrected image to be presented at the display 550 such that the user's eye 510 can receive an undistorted image. To ensure that the image at the user's eye 510 is substantially free of distortions created by the intrinsic parameters of the display lens, coordinates of image content in the image after the first correction 560 can be shifted in the version of the first image presented at the display 550 according to a distortion model to account for subsequent shifts due to distortions introduced by the display lens 530. In some embodiments, a polynomial model describing the display distortion of the form shown below can be created.

$${r}_{d} = {k}_{1}^{d} r + {k}_{2}^{d} {r}^{2} + … + {k}_{n}^{d} {r}^{n}$$

Here, r=\sqrt{x²+y²} and (x, y) represents a coordinate of a point in the image in an undistorted image, where (k₁^{d}, k₂^{d}, . . . , kₙ^{d}) are distortion coefficients that can be obtained by lens calibration. A distortion scale sᵣ for distortions introduced by the display lens can be defined as follows.

$${s}_{r} = \frac{{r}_{d}}{r}$$

From this, the translation of coordinate x, y in the undistorted image can be obtained as follows.

$$\{ \begin{matrix}{x}_{d} = {s}_{r} x \\ {y}_{d} = {s}_{r} y\end{matrix}$$

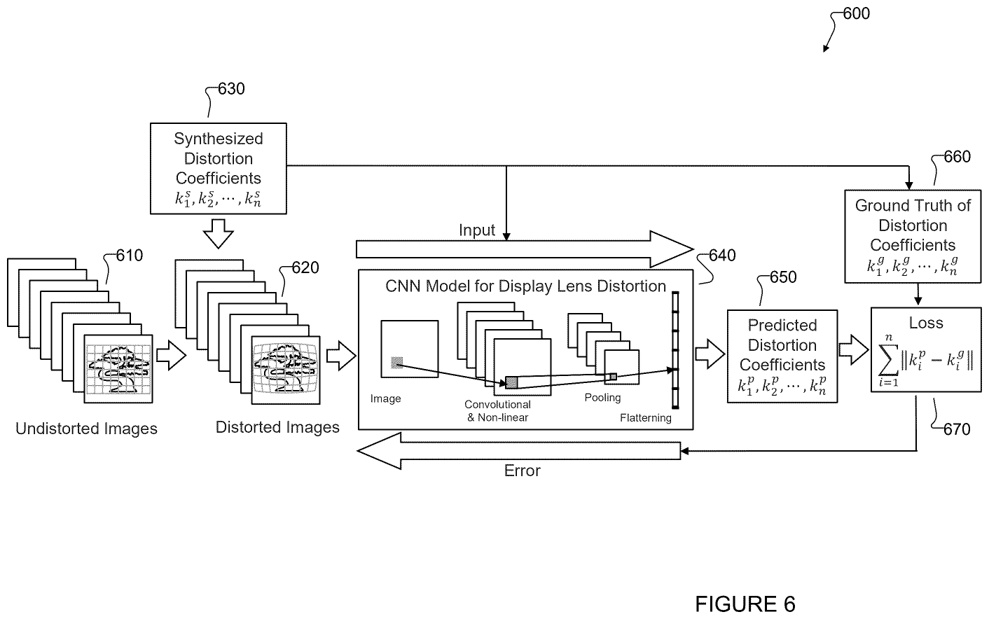

As described with reference to FIG. 6 below, in some embodiments, the values of the distortion coefficients for display lens distortions can be obtained by training a CNN model (such as the second CNN model 341 in FIG. 2) to predict distortion coefficients.

Although FIG. 5 illustrates aspects of one example of a display lens distortion model 500 for online calibration of a VST XR device, various changes may be made to FIG. 5. For example, models may use radial or other coordinate systems instead of the Cartesian system described in this example. Also, FIG. 5 does not limit the scope of this disclosure to any single approach for parameterizing the optics of a display lens.

FIG. 6 illustrates an example training process 600 to train a machine learning model to predict distortion coefficients for a display lens of a VST XR device in accordance with this disclosure. The training process 600 may, for example, be used to train the CNN model 341 in FIG. 3 or the CNN model 420 in FIG. 4 to predict distortion coefficients for the display lens 213 in FIG. 2. As shown in FIG. 6, a CNN model 640 includes an input layer, convolutional layers, and a flattering layer. An input of the CNN model 640 is image data (such as undistorted images 610 and distorted images 620), and an output of the CNN model 640 is a set of predicted distortion coefficients 650.

The model training process 600 can start by obtaining an initial set of undistorted images 610, which can be reprojected according to a set of synthesized distortion coefficients 630 to obtain a set of distorted images 620 that span value ranges of interest for each of the distortion coefficients. For each distortion coefficient of a distortion function, a range of values is defined. For each distortion coefficient, a set of distortion coefficients in the defined ranges is created. From these sets of distortion coefficients, a set of distorted images 620 for training the CNN model 640 is created. For example, for distortion coefficients k₁, k₂, . . . , kᵢ, . . . kₙ, the following range may be defined.

$${k}_{i} \to [ {k}_{i}^{l} , {k}_{i}^{r} ] , ( i = 1 , 2 , … n )$$

Here, kᵢ^{l} is a left bound, and kᵢ^{l} is a right bound. A value for kᵢ in this range can be set to obtain a set of distortion coefficients (k₁^{s}, k₂^{s}, . . . kₙ^{s}), and the input images 610 can be distorted to generate the distorted images 620 for training the CNN model 640.

To train the CNN model 640, synthesized distortion coefficients 630 (k₁^{s}, k₂^{s}, . . . kₙ^{s}) based on the properties of one or more display lenses may be generated and used to create the distorted images 620. The distorted images 620 are provided to the CNN model 640, which outputs the predicted distortion coefficients 650 (k₁^{p}, k₂^{p}, . . . kₙ^{p}). A loss 670 is computed from the predicted distortion coefficients and the associated ground truth distortion coefficients 660 (k₁^{g}, k₂^{g}, . . . kₙ^{g}) (in this case, synthesized distortion coefficients 630). In some cases, the following loss function may be used.

$$Loss = {\sum }_{i = 1}^{n} ‖ {k}_{i}^{p} - {k}_{i}^{g} ‖$$

By iteratively repeating the operations described above, the CNN model 640 can be trained, such as through supervised learning, to learn the relationships between distorted images and distortion coefficients and store the relationships as hyperparameters to the model. In embodiments in which the display lens(es) could introduce perceptible chromatic aberrations, once trained to generate distortion coefficients capturing the overall distortion introduced by the display lens(es), the CNN model 640 can be refined to generate correspondence distortion coefficients reflecting the variances in distortion for light of different wavelengths passing through the display lens(es) and creating chromatic aberrations.

Once the CNN model 640 has been pre-trained as described above, it has learned one or more relationships between input images and output distortion coefficients associated with the display lens(es). This knowledge can be stored in the generated hyperparameters of the CNN model 640. The CNN model 640 can be further trained to generate correspondence distortion coefficients (k₁, k₂, . . . kₙ) quantifying color-specific variances in the distortion induced by the display lens. For example, to predict distortion coefficients for each color channel for chromatic aberration correction, for each color channel of an image frame, the data in the channel can be provided to the CNN model 640, and distortion coefficients for this color channel can be determined using the same process described for the overall training of the CNN model 640. As a particular example, for an RGB image, distortion coefficients for the red, green, and blue color channels can be obtained separately as follows.

$$distortion coefficients = \{ \begin{matrix}{k}_{1}^{r} , {k}_{2}^{r} , … , {k}_{n}^{r} , for red channel , \\ {k}_{1}^{g} , {k}_{2}^{g} , … , {k}_{n}^{g} , for green channel , \\ {k}_{1}^{b} , {k}_{2}^{b} , … , {k}_{n}^{b} , for blue channel\end{matrix} ,$$

Here, (k₁^{r}, k₂^{r}, . . . , kₙ^{r}), (k₁^{g}, k₂^{g}, . . . , kₙ^{g}), (k₁^{b}, k₂^{b}, . . . , kₙ^{b}) are separate distortion coefficients for the red, green, and blue channels.

Although FIG. 6 illustrates one example of a training process 600 to train a machine learning model to predict distortion coefficients for a display lens of a VST XR device, various changes may be made to FIG. 6. For example, while FIG. 6 presents an example of a process utilizing convolutional neural networks as models, the present disclosure is not so limited, and other types of trainable machine learning models are possible and within the contemplated scope of this disclosure.

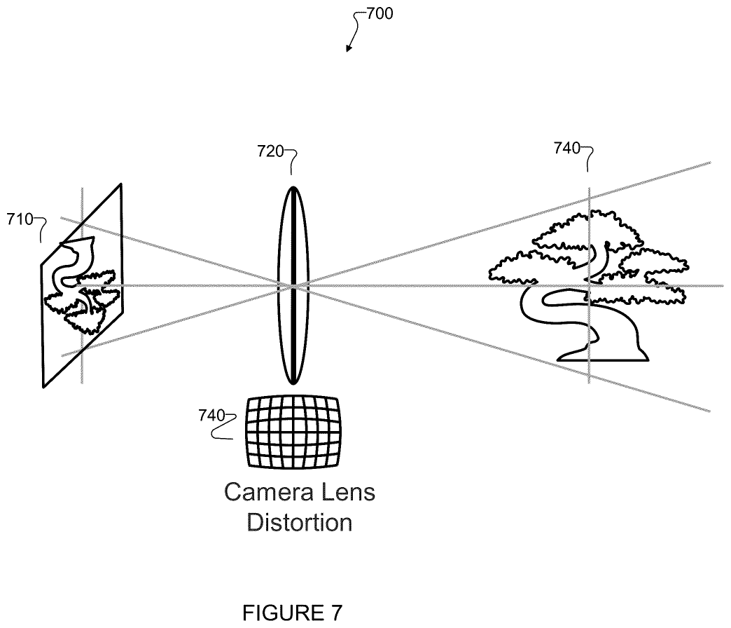

FIG. 7 illustrates an example distortion model 700 for a see-through camera in accordance with this disclosure. For example, the distortion model 700 may be used to model the behavior of the see-through camera 205 in FIG. 2. This can include distortion coefficients for which a CNN model of an online calibration pipeline (such as the CNN model 322 in FIG. 3 or the CNN model 420 in FIG. 4) can be trained to learn.

As shown in FIG. 7, an image frame 710 of a scene 730 is obtained based on light passing through a see-through camera lens 720 (which could represent the camera lens 207 in FIG. 2). Due to the geometry of the see-through camera lens 720 and other intrinsic parameters of the see-through camera, the image frame 710 embodies at least one distortion 740, where points within the image scene 730 occupy different locations within the coordinate system of the image frame 710 than they do when viewed through the “normal” lens of the human eye. For example, in cases where the see-through camera lens 720 is a wide-angle or fisheye lens, lines that appear straight to the human eye can appear curved, and close objects directly in front of the camera can occupy a disproportionately large fraction of the area of the image frame 710 relative to how they appear when viewed through the human eye.

As with the distortions introduced by the display lens, the distortions caused by the see-through camera can be modeled, such as by using a polynomial distortion function. For example, for the common case (because wide-angle and fisheye lenses are well suited to VST applications) in which the camera lens 720 is a wide-angle lens, the lens distortion can be modeled as follows.

$${r}_{d} = t ( 1 + {k}_{1} {t}^{2} + {k}_{2} {t}^{4} + {k}_{3} {t}^{6} + {k}_{4} {t}^{8} )$$

$$Here :$$

$$t = tan ( r )$$

$$r = \sqrt{{x}^{2} + {y}^{2}}$$

Also, (x, y) describes a coordinate of a given point in the image frame in an undistorted coordinate, and (k₁, k₂, k₃, k₄) are lens distortion coefficients for translating point (x, y) to a location in which it appears in a view obtained through the camera lens 720. Based on this, a distortion scale sᵣ can be given as follows.

$${s}_{r} = \frac{{r}_{d}}{r}$$

The translated location of (x, y) in an image frame distorted by the lens 720 can be computed as follows.

$$\{ \begin{matrix}{x}_{d} = {s}_{r} x \\ {y}_{d} = {s}_{r} y\end{matrix}$$

Although FIG. 7 illustrates one example of a distortion model 700 for a see-through camera, various changes may be made to FIG. 7. For example, in some embodiments, the size of an aperture and its effects on the focal properties of a lens may be factored into the model.

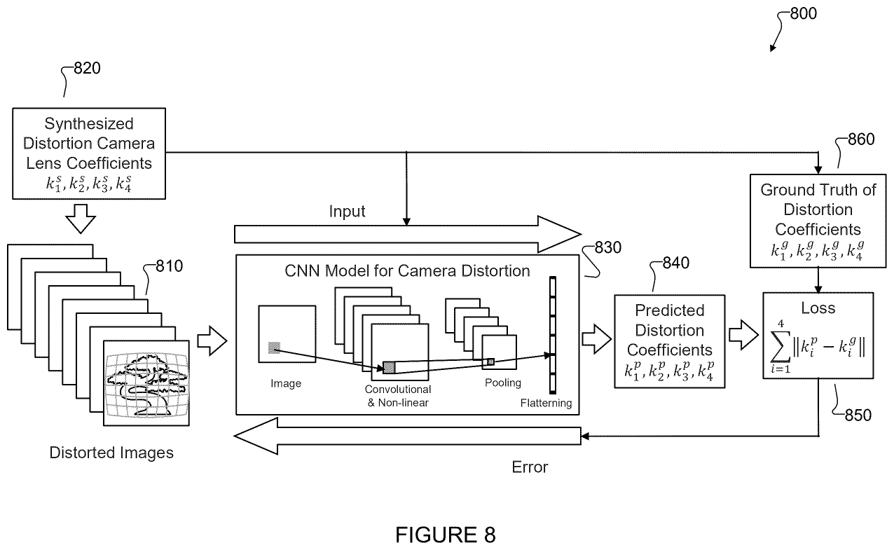

FIG. 8 illustrates an example training process 800 to train a machine learning model to generate distortion coefficients describing distortions to image frames caused by a lens of a see-through camera in accordance with this disclosure. The training process 800 may, for example, be used to train the CNN model 322. The CNN model 322 here can be trained to generate, based on image frames obtained from a see-through camera, distortion coefficients describing the distortions to the image frames caused by the lens of the see-through camera.

As shown in FIG. 8, training begins by generating or otherwise obtaining synthesized distortion coefficients 820 (k₁^{s}, k₂^{s}, k₃^{s}, k₄^{s}) according to the properties of one or more camera lenses (such as the lens 720 in FIG. 7) and applying the synthesized distortion coefficients 820 to undistorted image frames to create a training set of distorted image frames 810. The distorted image frames 810 are provided as inputs for a CNN model 830. The CNN model 830 outputs predicted distortion coefficients 840 (k₁^{p}, k₂^{p}, k₃^{p}, k₄^{p}), and the predicted distortion coefficients 840 and ground truth distortion coefficients 860 (k₁^{g}, k₂^{g}, k₁^{g}, k₄^{g}) are provided to a loss function 850. The loss function 850 is used to calculate a loss, which is fed back to the CNN model 830 to adjust internal weightings within the CNN model 830. By iteratively repeating the above-described process, the CNN model 830 can be trained such that the accuracy of the predicted distortion coefficients 840 improves over time.

Although FIG. 8 illustrates one example of a training process 800 to train a machine learning model to generate distortion coefficients describing distortions to image frames caused by a lens of a see-through camera, various changes may be made to FIG. 8. For example, while FIG. 8 presents an example of a process utilizing convolutional neural networks as models, the present disclosure is not so limited, and other types of trainable machine learning models are possible and within the contemplated scope of this disclosure.

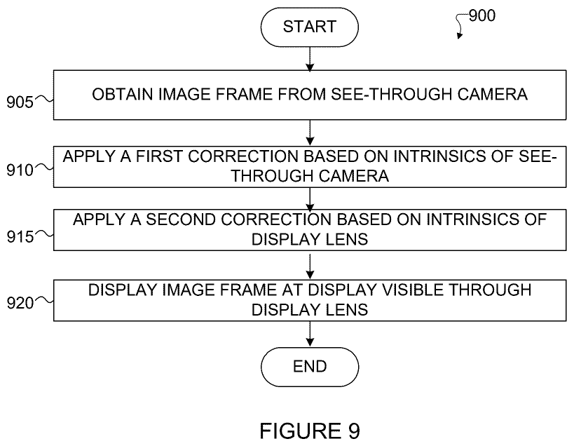

FIG. 9 illustrates an example method 900 for online calibration of a VST XR device in accordance with this disclosure. For example, the method 900 may be used for online calibration of the VST XR device 201 in FIG. 2. The VST XR device 201 can include at least one see-through camera 205, at least one display 211, and at least one display lens 213 through which the at least one display 211 can be viewed.

At operation 905, a processing platform implementing a VST XR pipeline (such as the VST XR pipeline 350) obtains an image frame (such as the image frame 361) of an operating environment using at least one see-through camera of a VST XR device. In some embodiments, the received frame is passed through the VST XR pipeline to be included in an XR display provided to a user of the VST XR device, such as via presentation on at least one display of the VST XR device for viewing via one or more display lenses of the VST XR device.

At operation 910, a first correction is applied to the see-through image frame, where the first correction “undistorts” distortions in the image frame caused by intrinsic parameters of the see-through camera. As used in this disclosure, the expression “intrinsic parameters” encompasses the constant effects that optics of a camera or lens have on an image frame. Examples of intrinsic parameters could include projection distortions due to the shape of the lens (such as pincushion and/or barrel distortions) and chromatic aberrations due to differences in refraction at different wavelengths of light. The first corrections can be determined based on an output of a first CNN model (such as the CNN model 322 in FIG. 3 or the CNN model 830 in FIG. 8) or other machine learning model. The first machine learning model can be pretrained (such as is described with reference to FIG. 8) to take, as input, image frames from see-through camera(s) and output predicted distortion coefficients of a distortion model. The distortion coefficients could describe warping or reprojecting locations in a coordinate space of the image frame obtained at operation 905 into a coordinate space that has been adjusted to offset the effects of the intrinsic parameters of the see-through camera(s).

At operation 915, a second correction can be applied to the image frame, where the second correction slightly “redistorts” the corrected image frame obtained by application of the first correction to offset the intrinsic parameters of one or more display lenses. In some embodiments, the second correction can be obtained based on distortion coefficients predicted by a second CNN model (such as the CNN model 341 in FIG. 3 or the CNN model 640 in FIG. 6) or other machine learning model.

At operation 920, following application of both the first and second corrections to correct for and offset the intrinsic parameters of the see-through camera(s) and the display lens(es), the image frame is rendered and presented for display on the at least one display of the VST XR device. The at least one display of the VST XR device can project an image to the user through the one or more display lenses.

Although FIG. 9 illustrates one example of a method 900 for online calibration of a VST XR device, various changes may be made to FIG. 9. For example, while shown as a series of steps, various steps in FIG. 9 could overlap, occur in parallel, occur in a different order, or occur any number of times (including zero times). Similarly, the CNNs (or other AI/ML models) used to perform various operations of FIG. 9 could reside on a separate platform from the VST XR device itself.

It should be noted that the functions described above can be implemented in an electronic device 101, 102, 104, server 106, or other device(s) in any suitable manner. For example, in some embodiments, at least some of the functions can be implemented or supported using one or more software applications or other software instructions that are executed by the processor 120 of the electronic device 101, 102, 104, server 106, or other device(s). In other embodiments, at least some of the functions can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining an image frame using at least one see-through camera of a video see-through (VST) extended reality (XR) device;
applying a first correction to the image frame based on one or more intrinsic parameters of the at least one see-through camera;
applying a second correction to the image frame based on one or more intrinsic parameters of at least one display lens of the VST XR device; and
after applying the first correction and the second correction, displaying the image frame on at least one display visible through the at least one display lens;
wherein the one or more intrinsic parameters of the at least one see-through camera are determined using a first machine learning model; and
wherein the one or more intrinsic parameters of the at least one display lens are determined by a second machine learning model.

2. The method of claim 1, wherein the first correction and the second correction are applied in conjunction with passing the image frame through a processing pipeline for generating an XR display based on the image frame.

3. The method of claim 2, wherein the first and second corrections are applied prior to or simultaneously with performing a correction for a predicted head pose of a user of the VST XR device.

4. The method of claim 1, wherein:
the image frame comprises image data in each of a plurality of color channels; and
the second correction is applied separately for each of the color channels.

5. The method of claim 1, further comprising:
determining whether to calibrate the VST XR device for at least one of: distortion in the at least one see-through camera or distortion from the at least one display lens;
responsive to determining to calibrate the VST XR device, providing the image frame to one or more of the first and second machine learning models; and
receiving, from one or more of the first and second machine learning models, at least one of: one or more updated intrinsic parameters of the one or more see-through cameras or one or more updated intrinsic parameters of the at least one display lens.

6. The method of claim 5, wherein at least one of the first and second machine learning models is remote from the VST XR device.

7. The method of claim 1, wherein the one or more intrinsic parameters of the at least one display lens comprise at least one of: barrel distortion or chromatic aberration.

8. A video see-through (VST) extended reality (XR) device comprising:
at least one see-through camera;
at least one display lens;
at least one display, wherein the at least one display is configured to be viewed through the at least one display lens; and
at least one processing device configured to:
obtain an image frame using the at least one see-through camera;
apply a first correction to the image frame based on one or more intrinsic parameters of the at least one see-through camera;
apply a second correction to the image frame based on one or more intrinsic parameters of the at least one display lens; and
after applying the first correction and the second correction, initiate display of the image frame on the at least one display;
wherein the one or more intrinsic parameters of the at least one see-through camera are determined using a first machine learning model; and
wherein the one or more intrinsic parameters of the at least one display lens are determined by a second machine learning model.

9. The VST XR device of claim 8, wherein the at least one processing device is configured to apply the first correction and the second correction in conjunction with passing the image frame through a processing pipeline for generating an XR display based on the image frame.

10. The VST XR device of claim 9, wherein the at least one processing device is configured to apply the first and second corrections prior to or simultaneously with performing a correction for a predicted head pose of a user of the VST XR device.

11. The VST XR device of claim 8, wherein:
the image frame comprises image data in each of a plurality of color channels; and
the at least one processing device is configured to apply the second correction separately for each of the color channels.

12. The VST XR device of claim 8, wherein the at least one processing device is further configured to:
determine whether to calibrate the VST XR device for at least one of: distortion in the at least one see-through camera or distortion from the at least one display lens;
responsive to determining to calibrate the VST XR device, provide the image frame to one or more of the first and second machine learning models; and
receive, from one or more of the first and second machine learning models, at least one of: one or more updated intrinsic parameters of the one or more see-through cameras or one or more updated intrinsic parameters of the at least one display lens.

13. The VST XR device of claim 12, wherein at least one of the first and second machine learning models is remote from the VST XR device.

14. The VST XR device of claim 8, wherein the one or more intrinsic parameters of the at least one display lens comprise at least one of: barrel distortion or chromatic aberration.

15. A non-transitory machine-readable medium containing instructions that when executed cause at least one processor to:
obtain an image frame using at least one see-through camera of a video see-through (VST) extended reality (XR) device;
apply a first correction to the image frame based on one or more intrinsic parameters of the at least one see-through camera;
apply a second correction to the image frame based on one or more intrinsic parameters of at least one display lens of the VST XR device; and
after applying the first correction and the second correction, initiate display of the image frame on at least one display visible through the at least one display lens;
wherein the one or more intrinsic parameters of the at least one see-through camera are determined using a first machine learning model; and
wherein the one or more intrinsic parameters of the at least one display lens are determined by a second machine learning model.

16. The non-transitory machine-readable medium of claim 15, wherein the instructions when executed cause the at least one processor to apply the first correction and the second correction in conjunction with passing the image frame through a processing pipeline for generating an XR display based on the image frame.

17. The non-transitory machine-readable medium of claim 15, wherein:
the image frame comprises image data in each of a plurality of color channels; and
the instructions when executed cause the at least one processor to apply the second correction separately for each of the color channels.

18. The non-transitory machine-readable medium of claim 15, further containing instructions that when executed cause the at least one processor to:
determine whether to calibrate the VST XR device for at least one of: distortion in the at least one see-through camera or distortion from the at least one display lens;
responsive to determining to calibrate the VST XR device, provide the image frame to one or more of the first and second machine learning models; and
receive, from one or more of the first and second machine learning models, at least one of: one or more updated intrinsic parameters of the one or more see-through cameras or one or more updated intrinsic parameters of the at least one display lens.

19. The non-transitory machine-readable medium of claim 18, wherein at least one of the first and second machine learning models is remote from the VST XR device.

20. The non-transitory machine-readable medium of claim 15, wherein the one or more intrinsic parameters of the at least one display lens comprise at least one of: barrel distortion or chromatic aberration.
